(19) United States
(12) Patent Application Publication
(10) Pub. No.: US 2024/0403141 A1
(43) Pub. Date: Dec. 5, 2024

(54) METHOD FOR PROCESSING DATA USING A DATA PROCESSING NETWORK COMPRISING A PLURALITY OF DATA PROCESSING MODULES, DATA PROCESSING MODULE AND DATA PROCESSING NETWORK

(71) Applicant: Robert Bosch Gmbh, Stuttgart (DE)

(72) Inventors: Stefan Egenter, Freiburg (DE); Michael Poehnl, Wurmberg (DE); Raphael Diziol, Kandel (DE)

(21) Appl. No.: 18/701,433

(22) PCT Filed: Sep. 28, 2022
(86) PCT No.: PCT/EP2022/076949

§ 371 Date: Jun. 22, 2024

(30) Foreign Application Priority Data
Oct. 18, 2021 (DE) 10 2021 211 731.7

(51) Int. Cl. G06F 9/52; G06F 9/48; G06F 9/50

(52) U.S. Cl. CPC G06F 9/52; G06F 9/485; G06F 9/5027

(57) ABSTRACT

A method for processing data, in particular for processing sensor data in a vehicle, using a data processing network. The data processing network has a plurality of data processing modules, which each comprise at least one data processing component, each data processing component being configured for a defined data processing task for processing the data, each data processing module receiving, as input data, data from at least one data source and/or output data from further data processing modules and generating output data which are network output data of the data processing network and/or input data of further data processing modules.

### BACKGROUND INFORMATION

Systems for driver assistance or automated driving consist of many individual software units that can usually be described in terms of data flow using graphs. These software units (often also called runnables, nodes, or data processing components) are characterized by the fact that a quantity of input data is processed and a quantity of output data is generated therefrom.

Such a graph of a system of data processing components visualizes a static view of the data flow through the system.

The various software units regularly form a complex data processing network with which sensor data are processed in order to perform actions based on the sensor data, where such actions can be, for example, control tasks in the context of autonomous driving of a vehicle. Data processing in the data processing network usually comprises a number of data processing steps or data processing tasks that build on each other and are carried out with the data processing components.

The execution or activation of a data processing task in such a data processing network usually depends on a corresponding condition, which can include stimuli such as time steps or the arrival of data. The control flow, which determines the execution of the data processing components, is usually derived from the data flow.

There are data-driven approaches in which the execution of the data processing tasks or data processing components is based on the data flow.

There are also approaches that use time-driven execution of the data processing tasks or of the data processing components. Such approaches have been enriched in recent years with concepts of worst-case execution time (longest possible execution time)

In a strictly data-driven approach, the execution of a data processing task or of a data processing component is triggered by the arrival of a data packet. Sending data packets in the execution of a data processing component can, in the case of a corresponding graph, lead to the immediate execution of a data processing component dependent thereon. Multiple parallel execution of a data processing component is even possible if new data packets arrive while a data processing component is still being executed. Such a system has a low latency, but a high number of possible states.

### SUMMARY

A method for data processing provided according to the present invention which aims to achieve the reproducibility of data processing with simultaneous high performance. In particular, multiple, parallel execution of a data processing component is to be made possible, and at the same time the number of possible states is to remain controllable and monitorable.

A method of the present invention for processing data is to be described here, in particular for processing sensor data in a vehicle, using a data processing network comprising a plurality of data processing modules which each comprise at least one data processing component, each data processing component being configured for a defined data processing task for processing the data, wherein each data processing module receives, as input data, data from at least one data source and/or output data from further data processing modules and generates output data, which in turn are network output data of the data processing network and/or input data of further data processing modules. According to an example embodiment of the present invention, the method includes the following steps carried out for at least one data processing module:
a) receiving at least one set of input data for performing the data processing tasks in the at least one data processing component of the relevant data processing module;
b) receiving a stimulus for activating the at least one data processing component of the data processing module and assigning a pipeline stage of the at least one data processing component;
c) when the set of input data has been received in step a) and the stimulus has been received in step b): activating the pipeline stage of the at least one data processing component of the data processing module and performing the data processing task for which the data processing component is configured with the respective input data to generate output data; and
d) providing the output data for further data processing and/or as network output data.

In particular, the method of the present invention is intended to solve the problem that predictability and reproducibility are very difficult to achieve with the classical approach. This makes it more difficult to implement safety measures, such as a software lockstep, in which the same software is executed simultaneously on two u processors. It is also difficult to recalculate (recompute) a recorded driving situation as accurately as possible, as a different runtime behavior and thus possibly a different result is to be expected.

The basis of the method according to the present invention described here is that a large number of data processing components of a data processing network are each combined to form so-called data processing modules, so that an additional higher-level structure of the data processing network results. At the level of this structure, input data and output data of the individual data processing components are combined within the module in each case and the data flow is controlled or monitored by the data processing network at this level.

In the automotive industry, with a high proportion of control technology, execution in time slices has always been dominant (e.g. 10 ms, 20 ms, 100 ms tasks). However, additional problems arise in particular when multi-core systems are used as hardware for carrying out data processing with such data processing networks. Fluctuating runtimes of the data processing components of a data processing network occur in particular on multi-core systems. Due to such fluctuating runtimes, the assignment of output data of a data processing component as input data of other data processing components becomes more difficult or no longer predictable. This predictability can be improved again if necessary, for example with concepts of maximum possible execution time/processing time. However, such concepts worsen the utilization capacity of the hardware (of the multi-core system). The hardware must be made considerably larger.

Highly complex driver assistance applications and automated driving applications in particular drastically increase the amount of sensor data to be processed. However, the required reaction time of such systems is comparable to or even lower than for classic driver assistance applications. That is, more, and more complex, calculations have to be carried out in a longer processing chain in a comparable period of time. This leads to an unacceptable latency in the existing time-driven approaches, as the additional latency adds up over the entire chain due to the transitions between the individual time slices.

The method according to the present invention presented makes it possible to combine approaches from data-driven execution with achievements in the time-driven execution of data processing components. This allows data processing networks to be operated in such a way that lower latency (better performance) occurs than in purely time-driven systems, and better reproducibility is achieved than in strictly data-driven systems. This makes it possible to fulfill the high requirements regarding latency in a system for automated driving, and at the same time to have a system that enables execution in software lockstep and exact reproducibility in the recompute. For step b), a suitable stimulus can be defined which determines the execution of the data processing in step c), the input data received in step a) then being used. The output data are then made available in step d) for subsequent processing steps. If the relevant data processing module is the last data processing module in a data processing network, the data can also be referred to as network output data or system output data, which are then, for example, also input data for a controller that processes this data or takes it into account for an application.

The method according to the present invention described enables both time-driven and data-driven execution of data processing tasks. The actual start of data processing takes place when the stimulus is received in step b). The data become visible, so to speak, to the data processing components when the stimulus arrives. Data structures that belong together temporally are therefore transferred together between data processing modules. Data are provided for the data processing components using the data processing modules provided in a higher-level structure. The structure of the higher-level data processing modules and the fact that data are provided at this level significantly reduce the number of system states of the entire data processing network.

It is also possible that at the time at which a stimulus to activate the data processing component is received in step b), no input data or no new input data (since the last processing of the relevant data processing task) are yet available. The method can then be configured so that the data processing task is not performed again, and there is simply a waiting period until the next reception of a stimulus. In variant embodiments of the method, an error output, e.g., to a central location, can also take place.

According to an example embodiment of the present invention, in step b), before the data processing task is performed, a pipeline stage is assigned to the relevant data processing component, in which the data processing task is then performed with the input data provided. The pipeline stage is like a kind of instance of the data processing task, e.g. with a reserved memory area on a microprocessor and possibly also reserved computing capacities on a microprocessor. Preferably, for each data processing component there exist a certain number of pipeline stages in which a data processing task can be performed in parallel (overlapping in time, but possibly starting and ending offset to each other). The number of pipeline stages indicates the degree of possible parallelism.

Preferably, according to an example embodiment of the present invention, a pipeline stage is only assigned if there is also a free pipeline stage in which no data processing task is currently taking place. If stimuli are repeatedly received one after the other so quickly that there is no free (already completed) pipeline stage, then preferably waiting takes place, or the start of the data processing task is postponed until later.

The use of pipeline stages is particularly useful in order to obtain current output data as early as possible for computing-time-intensive data processing tasks, because a new execution of the data processing task can already be started in a pipeline stage if a previously started execution of a data processing task in another pipeline stage has not yet been completed.

In this context, according to an example embodiment of the present invention, it is also particularly advantageous if method steps a) to d) are carried out repeatedly a plurality of times in such a way that the data processing task in method step c) is performed in an offset manner in parallel with one another in a plurality of pipeline stages.

According to an example embodiment of the present invention, it is particularly preferred if the following step is carried out after step d):
e) providing a validation data set consisting of the set of input data, the stimulus, and/or the output data for validating the execution of the at least one data processing task with the at least one data processing component.

According to an example embodiment of the present invention, it is preferable if the validation data set additionally contains at least one time information item which enables a time of the stimulus and/or a time information item about the processing of the at least one data processing task.

Such an item of time information can be provided, for example, by recording the start and end of the executions of the data processing tasks. This allows the processed input data and the generated output data to be displayed on a common logical timeline, and test calculations of the described method are made possible.

According to an example embodiment of the present invention, it is possible for a data processing module that processes output data from another data processing module as input data to start processing when a stimulus occurs as an activation. Compared to the time-driven approach, this prevents the additional latency caused by WCET and until the start of the time slice of the receiving data processing module.

The method according to the present invention described here achieves reproducibility in the execution of the individual data processing tasks because the information relating to the input data processed in each case is reproducible.

In the method according to the present invention presented, a data processing module always has a frozen view of the world, or of the input data being processed during an execution (execution of step c). The input data do not change during an execution of the method. This is achieved in that the incoming input data can be collected in step a), and the data can be checked and passed on atomically in logical time. In order to process the output data of a data processing module consistently with regard to its execution by other data processing modules, the output data are preferably also collected.

According to an example embodiment of the present invention, it is preferable if at least one timer is used to generate the stimulus used in step b), which timer specifies a time pattern for regular repetition of the execution of the data processing tasks with the data processing components.

The timer can, for example, be a corresponding module on a hardware unit on which the data processing network is operated and which emits a timer signal for each data processing module at regular intervals, which signal forms the stimulus and triggers execution of the method.

According to an example embodiment of the present invention, it is also preferred if at least one availability signal indicating the availability of data is used to generate the stimulus used in step b). This availability signal may, for example, have been generated by a previous execution of the described method in another data processing module.

It is particularly preferable if the stimulus is formed by a combination of a timer and an availability signal. Whenever new data are displayed via an availability signal, the data processing module is put into readiness to respond to the timer. Only if both the timer and the (at least one) availability signal indicate that data processing is to be started does data processing take place in the data processing components of the relevant data processing module (step c)).

It is particularly preferred if step a) is carried out using an input data receiving module of the data processing module, which has an input memory for buffering input data that are not yet complete and which carries out a completeness check of the set of input data.

In this context, it is particularly preferred if an input memory of the input data receiving module has a plurality of input stages for storing input data, wherein a change of the input stage takes place between the reception of different input data, so that a series of the most recently received input data is available in the input data receiving module, wherein at least one set of input data is determined by accessing input data stored in the input memory as a result of the reception of a stimulus in step b).

An access can take place if a stimulus is received in step b).

When the stimulus arrives, a view of the input data is formed. A set of input data is defined that is processed in the relevant pipeline stage. This set of input data can also be stored in parallel so that the execution of the data processing task with the data processing component can be traced.

Various working methods are possible with the input stages of the input memory. It is possible that when a stimulus arrives, only the latest input data from the series of most recently received input data that have not yet been supplied to the data processing task are processed. It is also possible for (individual) input data from the series of input data to be processed multiple times, so that the data processing task is always carried out for a sliding window of input data (e.g. N sets of input data, looking back).

According to an example embodiment of the present invention, it is also preferred if the at least one data processing component is configured to process a series of recently received input data together as a set of input data in order to generate output data.

Preferably, according to an example embodiment of the present invention, an input stage is accessible via an input stage index, which is modified when triggered by the reception of a stimulus in step b).

For example, the input stage index is incremented each time a stimulus is received.

According to an example embodiment of the present invention, it is also preferred if step d) is carried out with an output data provision module which has an output memory in which output data that is not yet complete are buffered.

In this context, it is particularly advantageous if the output memory of the output data provision module has a plurality of output stages for storing a set of output data.

According to an example embodiment of the present invention, the data processing module therefore preferably has special gates (input data reception module=input gate and output data provision module=output gate) in order to perform the data processing task.

These gates allow a controlling unit to control the data flow between the data processing modules. If the controlling unit now synchronizes the start and end of the executions of the data processing modules with the forwarding of data via the gates, it is possible to control which data processing module is executed when and with which data. To decide whether to start a data processing module, the aforementioned stimulus is evaluated.

In variant embodiments of the present invention, output data provided in step d) are at least partially used as input data for a new execution of method steps a) to d) (and possibly also step e)) with the same data processing module.

This describes a type of feedback that enables a data processing module to process historical data from a previous execution of a data processing module. Such feedback enables a certain type of memory capability in a data processing network.

If there is feedback within the calculation steps of a data processing module, this data path is designed in such a way that it is realized via the relevant input data receiving module and the relevant output data receiving module of the data processing module.

Preferably, according to the present invention, output data provided in step d) comprise partial data quantities generated by different data processing components of the data processing module when performing the data processing tasks, wherein the output data are not provided in step d) until all partial data quantities forming the output data are available.

Partial data quantities arise, for example, because the data processing tasks of different data processing components within the data processing module have processing times of different lengths. By collecting the partial data quantities until the output data are completely available and by providing all partial data quantities together, it is considerably easier to trace which data were available when during data processing with the data processing network.

According to an example embodiment of the present invention, it is also preferable if an availability signal is also generated in step d), which can be used to recognize that output data have been provided for further processing.

As described above, such an availability signal can serve as a stimulus for further executions of the method described.

According to an example embodiment of the present invention, it is particularly preferred if the following step is optionally carried out during step c):

Aborting the execution of the data processing task in one instance and restarting step c) with other input data if an abort signal was received.

Such a procedure is particularly suitable if the number of available pipeline stages has been exhausted or all pipeline stages are occupied with the execution of the data processing task, but new input data have arrived and the processing of these new input data is assigned a higher importance than the completion of the current executions of data processing tasks in the pipeline stages.

It is also preferred if at least one of the following pieces of information is permanently recorded during the execution of the method for later processing:
sets of input data received in step a);
stimuli received in step b);
output data provided in step d); and
availability signals provided in step d).

It is particularly preferable if the recording also includes the storage of time information, which enables the temporal assignment of the method execution to a timeline.

Such a recording can be made, for example, in an additional debug data memory in order to subsequently perform debug tasks in which any errors in the individual data processing components can be investigated. Such a recording can also be used in a finished system in use, in order to recognize in particular hardware-related errors in the execution of data processing tasks by means of a subsequent check, and then to perform corrective tasks.

Also to be described herein is a data processing module for a data processing network for carrying out the described method, having an input data receiving module to which an input memory is assigned and an output data provision module to which an output memory is assigned, and further having at least one data processing component for performing a data processing task based on the input data in the input memory and for generating output data for storage in the output memory.

It is particularly advantageous if at least the input memory or the output memory have a plurality of stages for storing a set of input data or output data.

Furthermore, a data processing network according to the present invention comprising a plurality of such data processing modules is to be described.

The explanations of the method provided above are transferable and applicable to the data processing module and the data processing network.

The method is explained in more detail below with reference to the figures.

### BRIEF DESCRIPTION OF THE DRAWINGS

FIG. 1 shows a vehicle in which a described data processing network is used and in which the described method according to the present invention is applied.

FIG. 2 shows a data processing module for carrying out the method described according to the present invention.

FIG. 3 shows a flowchart of the execution of data processing tasks in different pipeline stages, according to an example embodiment of the present invention.

FIG. 4 is a further representation of a data processing module for carrying out the method according to an example embodiment of the present invention.

FIG. 5 shows a type of data processing with a described method according to an example embodiment of the present invention, shown on a timeline.

FIG. 6 shows a further type of data processing with a described method according to an example embodiment of the present invention, shown on a timeline.

FIG. 7 shows yet another type of data processing with a described method according to an example embodiment of the present invention, shown on a timeline.

### DETAILED DESCRIPTION OF EXAMPLE EMBODIMENTS

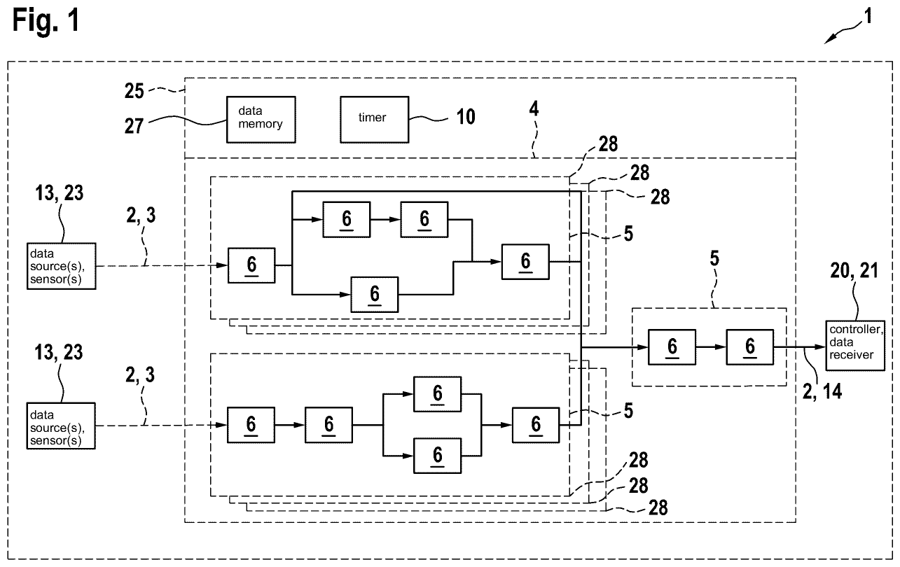

FIG. 1 schematically shows a vehicle 1. The vehicle 1 is in particular a road vehicle, for example a passenger car or a truck. The vehicle 1 has sensors 23 for recording information, such as surroundings data from the surroundings of the vehicle 1, which can be used by various driver assistance systems. Such systems can be, for example, active or passive safety systems or systems for autonomous (or semi-autonomous) driving. Such systems are shown in FIG. 1 as a controller 20.

These data must be prepared so that the controller 20 can process the data from the sensors 23. For this purpose, the vehicle 1 has a data processing network 4. The sensors 23 form data sources 13 for this data processing network 4, which provide sensor data 3 to the data processing network 4. The controller 20 forms an output data receiver 21 for this data processing network 4, which receives network output data 14 of the data processing network 4.

The data processing network 4 consists of a plurality of data processing modules 5, each of which consists of (one or more) data processing components 6. It is schematically indicated here that the individual data processing components 6 can each be present in parallel in a plurality of pipeline stages 28, so that data processing tasks with the data processing components 6 can be performed in parallel with each other/in an overlapping manner. The data processing network 4 with the data processing modules 5 and the data processing components 6 is preferably realized on a hardware unit 25, which in particular has a data memory 27 on which the data processing network 4 can store data 2 and which can also provide various other hardware functions for the data processing network 4, for example a timer 10.

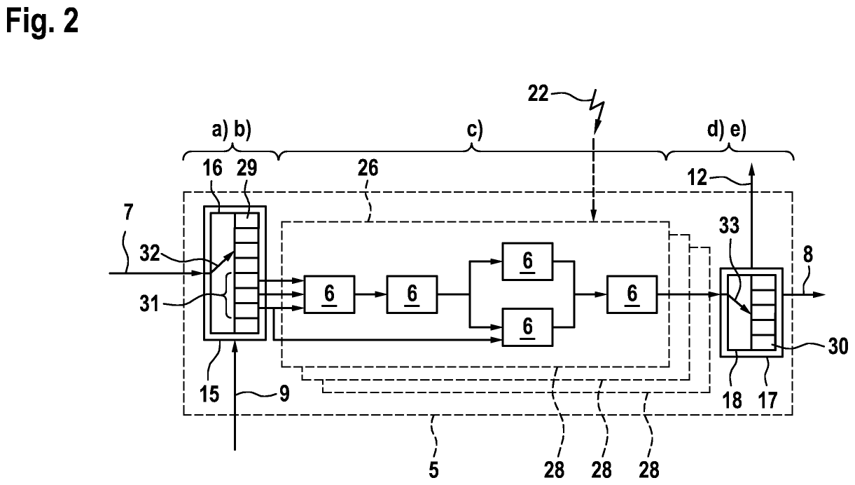

FIG. 2 shows a possible variant embodiment of data processing modules 5 for the described data processing network 4. The method described is carried out at the level of each individual data processing module 5. Each data processing module 5 has an input data receiving module 15 having an input memory 16 for receiving input data 7 and an output data provision module 17 having an output memory 18 for providing output data 8, and a data processing component structure 26 having data processing components 6 for data processing from the input data 7 to the output data 8. The input data receiving module 15 can have an interface for receiving a stimulus 9 with which the data processing with the data processing components 6 can be initiated. The output data provision module 17 can have an interface for emitting an availability signal 12 when the data processing with the data processing components 6 is complete and the output data 8 are available.

The method steps a) and b) of the described method relate to the reception of the input data 7 and are primarily carried out with the input data reception module 15. The method steps d) and e) of the described method concern the provision of output data 8 and they are primarily carried out with the output data provision module 17. The actual data processing takes place in step c) in the data processing components 6, which form a data processing component structure 26 of the relevant data processing module 5.

The implementation of the pipeline stages 28 already indicated in FIG. 1 is described in more detail here. The pipeline stages 28 preferably relate only to the data processing components 6 of the data processing module 5. All pipeline stages 28 preferably access a common input data receiving module 15 and a common output data provision module 17. The input memory 16 of the input data receiving module 15 and the output memory 18 of the output data provision module 17 preferably each have a plurality of input stages 29 and output stages 30, which are each accessible via an input stage index 32 and an output stage index 33, respectively. When the data processing task is performed in the data processing component 6 in a pipeline stage 28, a series 31 of input data 7 is accessed in each case, thus defining a set of input data 7 for the relevant data processing task processing. The series 31 of input data 7, which forms the set of input data 7, can be shifted each time a stimulus arrives. In variant embodiments, this series 31 has a fixed length. In other variant embodiments, this series always relates only to the input data 7 that arrived last (since the last start of an execution of the data processing task in a pipeline stage).

FIG. 2 also shows (purely schematically) the possibility of an abort signal, which causes the abortion of the execution of the data processing in a pipeline stage (28).

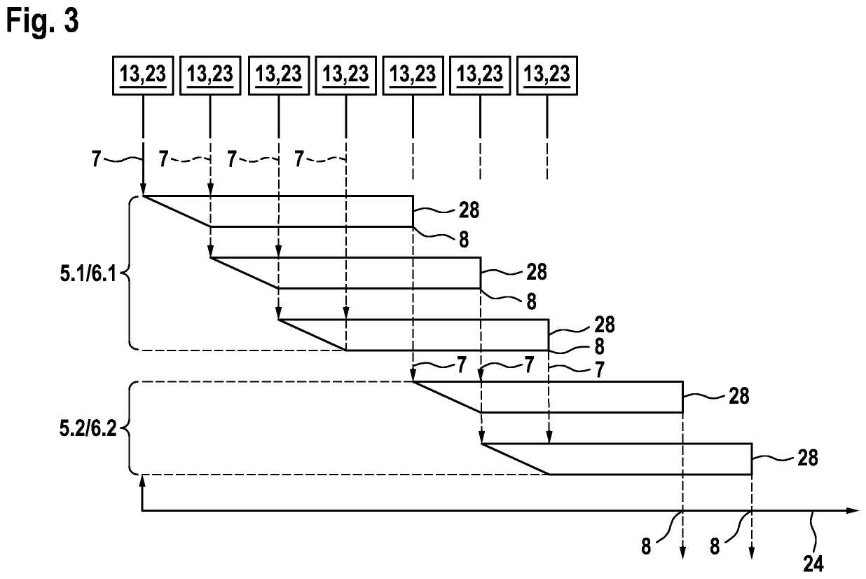

The representation of the method on a timeline 24 in FIG. 3 makes it possible to explain the advantages of carrying out the method in pipeline stages 28 with reference to the faster availability of output data through the use of the pipeline stages 28. FIG. 3 above shows that input data 7 from sensors 23 or from other data sources 13 arrive regularly and repeatedly. Shown below is the execution of data processing tasks which build on each other, in two data processing modules 5.1 and 5.2 and the data processing components 6.1 and 6.2 contained in each of them. The fact that the two data processing tasks are each performed multiple times in parallel means that output data 8 can be provided earlier. This applies in particular if a series of input data is processed for each data processing task, which series accumulates sequentially/over a period of time in the relevant input data receiving module.

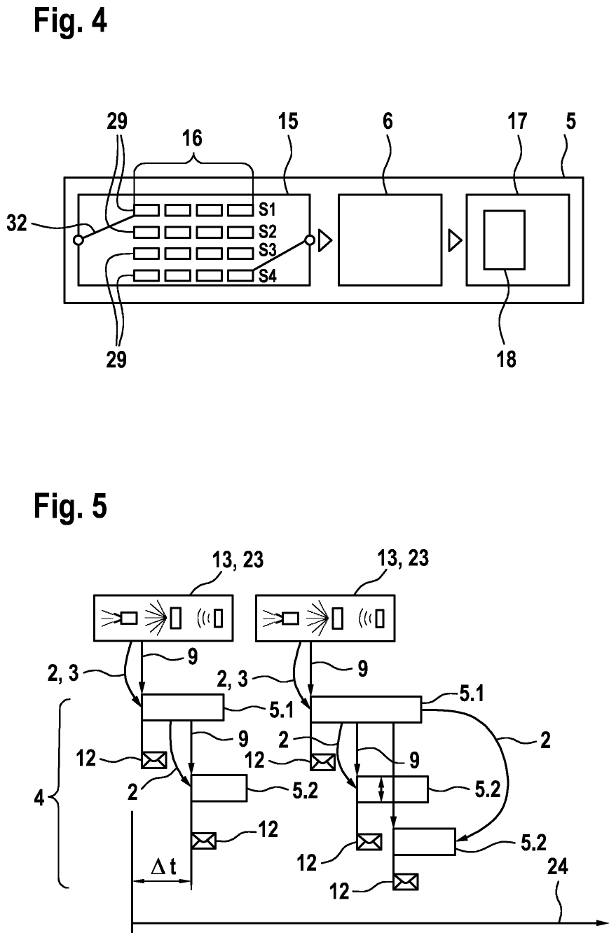

FIG. 4 shows a further representation of a data processing module 5 with the input data receiving module 15, the data processing components 6, and the output data provision module 17. In the input data receiving module 15, the input memory 16 for input data is shown in more detail. It can be seen that the input memory 16 has input stages 29 which are accessible via an input stage index 32. The output memory 18 of the output data provision module 17 is also shown schematically here, which output memory can be structured corresponding to the input memory 16, although this is not shown in detail here.

FIGS. 5, 6 and 7 show various types of data processing that can be carried out with the described data processing network 4 or with the described method.

The representations each show different data processing modules 5.1, 5.2, and/or 5.3, wherein in each case the duration of the execution of the data processing operations with the data processing components 6 belonging to the associated data processing modules 5 is plotted as bars on the timeline 24. The data sources 13 (here sensors 23), with which data 2 (here sensor data 3) can be fed into the data processing network 4, are shown schematically at the top in each case.

The individual data processing modules 5.1, 5.2, and/or 5.3 are shown a plurality of times one after the other across the timeline 24. This shows that the individual data processing modules 5.1, 5.2, and/or 5.3 are each executed multiple times, each time accessing different input data. The execution of one of the data processing modules 5.1, 5.2, and/or 5.3 in each case starts when a stimulus 9 is present.

FIGS. 5, 6, and 7 each show different types of stimuli 9 that can be used here.

FIG. 5 shows that only availability signals 12 that indicate an availability of data for performing certain data processing tasks with data processing modules 5.1, 5.2, and/or 5.3 are used as stimuli 9. The method shown in FIG. 4 is quite uncontrolled in terms of data. As soon as new data are available, the execution of the respective data processing modules 5.1, 5.2, and/or 5.3 starts. This does indeed achieve a high processing speed. However, there is also a greatly reduced traceability of which data were processed by the relevant data processing module 5.1, 5.2, and/or 5.3. This applies in particular because the duration of the data processing with the data processing modules 5.1, 5.2 and/or 5.3 cannot be predicted exactly, and therefore there is no, or only a low degree of, reproducibility as to which data processing module 5.1, 5.2, and/or 5.3 reacts to which input data. The term “reproducibility” here refers to the reproducibility of the data processing with the data processing network 4. In this context, low reproducibility means that a very high level of effort is required to reproduce the data processing with the individual data processing modules 5.1, 5.2 and/or 5.3, as is necessary for example for debugging tasks or for tasks to ensure the correctness of data processing in redundant systems.

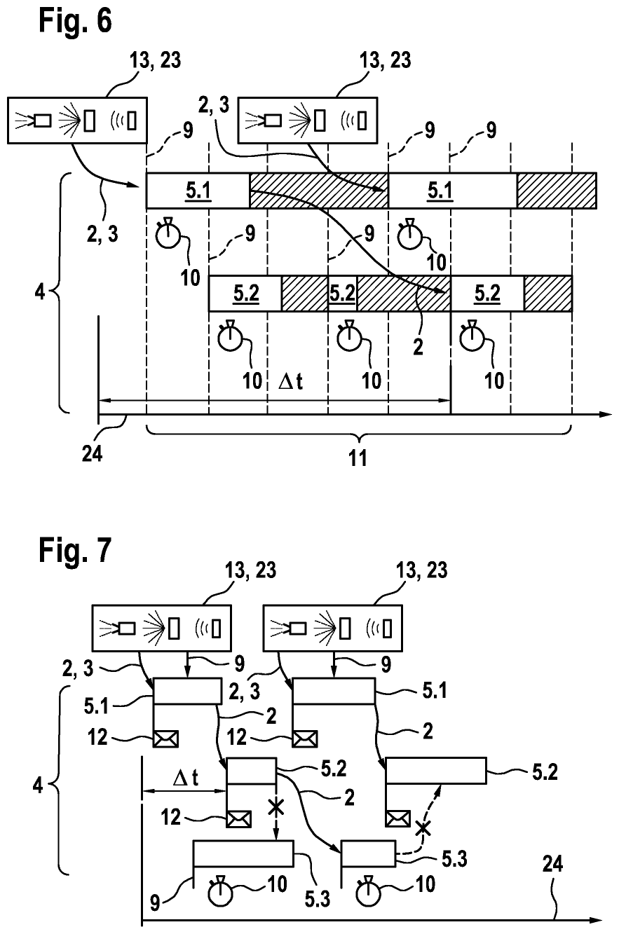

FIG. 6 shows that signals from a timer 10 which follow a fixed time pattern 11 are used in each case as stimuli 9. Such stimuli 9 for triggering the data processing with the data processing modules 5.1, 5.2, and/or 5.3 can be used to ensure that it is always precisely known with which input data the data processing with the data processing modules 5.1, 5.2, and/or 5.3 starts.

This achieves a high level of reproducibility as described above, but at the same time drastically reduces the performance of the data processing network 4. The performance of the data processing network 4 here refers to the ability of the data processing network 4 to be operated with as few hardware resources as possible. This is because it must be ensured that data processing with a data processing module (e.g. data processing module 5.1) is completed before another data processing module is started, which processes output data 8 from the first data processing module as input data (e.g. data processing module 5.2). Because the duration of the data processing with the data processing modules 5.1, 5.2, and/or 5.3 cannot be predicted exactly, the time pattern must be adequately designed on the basis of the longest possible execution time.

The variant embodiments according to FIG. 7 combine aspects of the variant embodiments according to FIGS. 5 and 6 in order to achieve high reproducibility and good performance. Depending on the task, the data processing network 4 uses availability signals 12 or timers 10 as stimuli 9.

1-17. (canceled)

18. A method for processing data using a data processing network including a plurality of data processing modules, which each include at least one data processing component, wherein each data processing component is configured for a defined data processing task for processing the data, wherein each data processing module receives, as input data, data from at least one data source and/or output data from further data processing modules and generates output data which are network output data of the data processing network and/or input data of further data processing modules, wherein the following steps are carried out in the method for at least one data processing module:
a) receiving at least one set of input data for performing the data processing task in the at least one data processing component of the data processing module;
b) receiving a stimulus for activating the at least one data processing component of the data processing module and assigning a pipeline stage of the at least one data processing component;
c) when the set of input data has been received in step a) and the stimulus has been received in step b): activating the pipeline stage of the at least one data processing component of the data processing module and performing the data processing task for which the data processing component is configured with the set of input data to generate output data; and
d) providing the output data for further data processing and/or as network output data.

19. The method according to claim 18, wherein the method steps a) to d) are carried out repeatedly a plurality of times in such a way that the data processing task in method step c) is performed in an offset manner in parallel with one another in a plurality of pipeline stages.

20. The method according to claim 18, wherein at least one timer is used to generate the stimulus used in step b), the timer specifying a time pattern for regular repetition of the execution of the data processing task with the data processing component.

21. The method according to claim 18, wherein at least one availability signal that indicates availability of data is used to generate the stimulus used in step b).

22. The method according to claim 18, wherein step a) is carried out with an input data receiving module of the data processing module, which has an input memory for buffering input data that is not yet complete and which carries out a completeness check of the set of input data.

23. The method according to claim 22, wherein the input memory of the input data receiving module has a plurality of input stages for storing input data, wherein a change of the input stage takes place between the reception of different input data, so that a series of most recently received input data is available in the input data receiving module, wherein at least one set of input data is determined by accessing input data stored in the input memory as a result of the reception of a stimulus in step b).

24. The method according to claim 18, wherein the at least one data processing component is configured to process a series of most recently received input data together as the set of input data in order to generate the output data.

25. The method according to claim 18, wherein an input stage is accessible via an input stage index which is modified when triggered by the reception of a stimulus in step b).

26. The method according to claim 18, wherein in step d) is carried out with an output data provision module which has an output memory in which output data which are not yet complete are buffered.

27. The method according to claim 26, wherein the output memory of the output data provision module has a plurality of output stages for storing a set of output data.

28. The method according to claim 18, wherein the output data provided in step d) are used at least partially as input data for a new execution of method steps a) to d) with the same data processing module.

29. The method according to claim 18, wherein the output data provided in step d) includes partial data quantities generated by different data processing components of the data processing module when performing the data processing tasks, wherein the provision of the output data in step d) does not take place until all partial data quantities forming the output data are available.

30. The method according to claim 18, wherein in step d) an availability signal is additionally generated, based on which it can be recognized that the output data have been provided for further processing.

31. The method according to claim 18, wherein during step c) the following step is optionally carried out:
aborting the execution of the data processing task in a pipeline stage, and restarting step c) with other input data when an abort signal has been received.

32. A data processing module for a data processing network, comprising:
an input data receiving module to which an input memory is assigned;
an output data provision module to which an output memory is assigned;
at least one data processing component for performing a data processing task based on input data in the input memory and for generating output data for storage in the output memory;
wherein the data processing module is configured to:
a) receive at least one set of input data for performing the data processing task in the at least one data processing component of the data processing module,
b) receive a stimulus for activating the at least one data processing component of the data processing module and assigning a pipeline stage of the data processing component,
c) when the set of input data has been received in step a) and the stimulus has been received in step b): activate the pipeline stage of the at least one data processing component of the data processing module and perform the data processing task for which the data processing component is configured with the set of input data to generate output data, and
d) provide the output data for further data processing and/or as network output data.

33. The data processing module according to claim 32, wherein at least the input memory or the output memory has a plurality of stages for storing the set of input data or the output data.

34. A data processing network, comprising:
a plurality of data processing modules, each data processing module of the data processing modules including:
an input data receiving module to which an input memory is assigned;
an output data provision module to which an output memory is assigned;
at least one data processing component for performing a data processing task based on input data in the input memory and for generating output data for storage in the output memory;
wherein each data processing module is configured to:
a) receive at least one set of input data for performing the data processing task in the at least one data processing component of the data processing module,
b) receive a stimulus for activating the at least one data processing component of the data processing module and assigning a pipeline stage of the data processing component,
c) when the set of input data has been received in step a) and the stimulus has been received in step b): activate the pipeline stage of the at least one data processing component of the data processing module and perform the data processing task for which the data processing component is configured with the set of input data to generate output data, and
d) provide the output data for further data processing and/or as network output data.
